(19) United States
(12) Patent Application Publication
(10) Pub. No.: US 2008/0286626 A1
(43) Pub. Date: Nov. 20, 2008

(54) BIS(ARYL)SULFONIMIDE FUNCTIONALIZED ION CONDUCTING POLYMERS

(75) Inventor: David Olmeijer, San Francisco, CA (US)

Correspondence Address: MORGAN, LEWIS & BOCKIUS, LLP, ONE MARKET SPEAR STREET TOWER, SAN FRANCISCO, CA, 94105, US

(73) Assignee: Polyfuel, Inc., Mountain View, CA (US)

(21) Appl. No.: 12/123,342

(22) Filed: May 19, 2008

Related U.S. Application Data
(60) Provisional application No. 60/938,984, filed on May 18, 2007.
(60) Provisional application No. 61/015,572, filed on Dec. 20, 2007.

(51) Int. Cl. H01M 8/10; B01J 39/04; B01J 47/00

(52) U.S. Cl. 429/30; 521/25; 521/27

(57) ABSTRACT

The invention provides ion conducting copolymers containing pendant bis(aryl)sulfonimide groups that are used to make polymer electrolyte membranes (PEM's), catalyst coated proton exchange membranes (CCM's) and membrane electrode assemblies (MEA's) that are useful in fuel cells and their application in electronic devices, power sources and vehicles.

### CROSS REFERENCE TO RELATED APPLICATIONS

The present application claims priority to U.S. Provisional Application Ser. No. 60/938,984, filed May 18, 2007 and to U.S. Provisional Application Ser. No. 61/015,572, filed Dec. 20, 2007, which are incorporated herein by reference.

### FIELD OF THE INVENTION

This invention relates to bis(aryl)sulfonimide functionalized ion conducting polymers that are useful in making polymer electrolyte membranes used in fuel cells.

### BACKGROUND OF THE INVENTION

Fuel cells are promising power sources for portable electronic devices, electric vehicles, and other applications due mainly to their non-polluting nature. Polymer electrolyte membrane based fuel cells such as direct methanol fuel cells (DMFCs) and hydrogen fuel cells, have attracted significant interest because of their high power density and energy conversion efficiency. The “heart” of a polymer electrolyte membrane based fuel cell is the so called “membrane-electrode assembly” (MEA), which comprises a proton exchange membrane (PEM), catalyst disposed on the opposite surfaces of the PEM to form a catalyst coated membrane (CCM) and a pair of electrodes (i.e., an anode and a cathode) disposed to be in electrical contact with the catalyst layer.

The need for a good membrane for fuel cell operations requires balancing various properties of the membrane. Such properties included proton conductivity, fuel-resistance, chemical stability and fuel crossover, especially for high temperature applications, fast start up and durability.

### SUMMARY OF THE INVENTION

The invention relates to ion conducting polymers containing pendant bis(aryl)sulfonimide groups. Pendant bis(aryl)sulfonimide groups are protogenic and contribute to the proton flux through PEMs made form such polymers. Other ion conducting groups, such as sulfonic acid groups, may also be present in such ion conducting polymers.

In a preferred embodiment, the ion-conducting copolymer comprises (i) at least one of an ion conducting monomer and ion-conducting oligomer covalently linked to (ii) at least one of a non-ionic monomer and a non-ionic oligomer, wherein at least one of the ion conducting monomers and ion conducting oligomers contains a pendant bis(aryl)sulfonimide group.

Examples of such ion conductive copolymers are set forth in Formula I:

[[—((Ar₁-T)ₜ-Ar₁-Z-(Ar₂—U)ᵤ—Ar₂-Z-)ᵢ]ₐ^{m}/(—(Ar₃—V)ᵥ—Ar₃-Z-)_{b}ⁿ/[—((Ar₄—W)_{w}—Ar₄-Z-(Ar₅—X)ₓ—Ar₅-Z-)ⱼ]_{c}^{o}/(—(Ar₆—Y)_{y}—Ar₆-Z-)_{d}^{p}/] Formula I
wherein Ar₁, Ar₂, Ar₃, Ar₄, Ar₅, and Ar₆ are aromatic moieties;
at least one of Ar₁ comprises a pendant bis(aryl)sulfonimide group;
at least one of Ar₃ comprises a pendant bis(aryl)sulfonimide group;
T, U, V W, X and Y are linking moieties;
Z is independently —O— or —S—;
i and j are independently integers greater than 1;
t, u, v, w, x, and y are independently 0 or 1
a, b, c, and d are mole fractions wherein the sum of a, b, c and d is 1, at least one of a and b is greater than 0 and at least one of c and d is greater than 0; and
m, n, o, and p are integers indicating the number of different oligomers or monomers in the copolymer.

In the foregoing formula:
—((Ar₁-T)ₜ-Ar₁-Z-(Ar₂—U)ᵤ—Ar₂-Z-)ᵢ] is an ion conducting oligomer where one or more of Ar1 contains SO₃M;
(—(Ar₃—V)ᵥ—Ar₃-Z-) is an ion conducting comonomer where one or both of Ar3 contains SO₃M
—((Ar₄—W)_{w}—Ar₄-Z-(Ar₅—X)ₓ—Ar₅-Z-)ⱼ is a non ionic oligomer; and
(—(Ar₆—Y)_{y}—Ar₆-Z-) is a comonomer.

The invention also includes PEMs, CCMs and MEAs made from such ion conducting polymers, fuel cells containing such PEMs, CCMs and MEAs and electronic devices, power supplies and vehicles containing such fuel cells.

### BRIEF DESCRIPTION OF THE DRAWINGS

FIG. 1 is a graph of methanol permeability versus conductivity for a PEMs made from a sulfonic acid ion conducting polymer and the same polymer where 20% of the sulfonic acid groups are replaced with bis(aryl)sulfonimide.

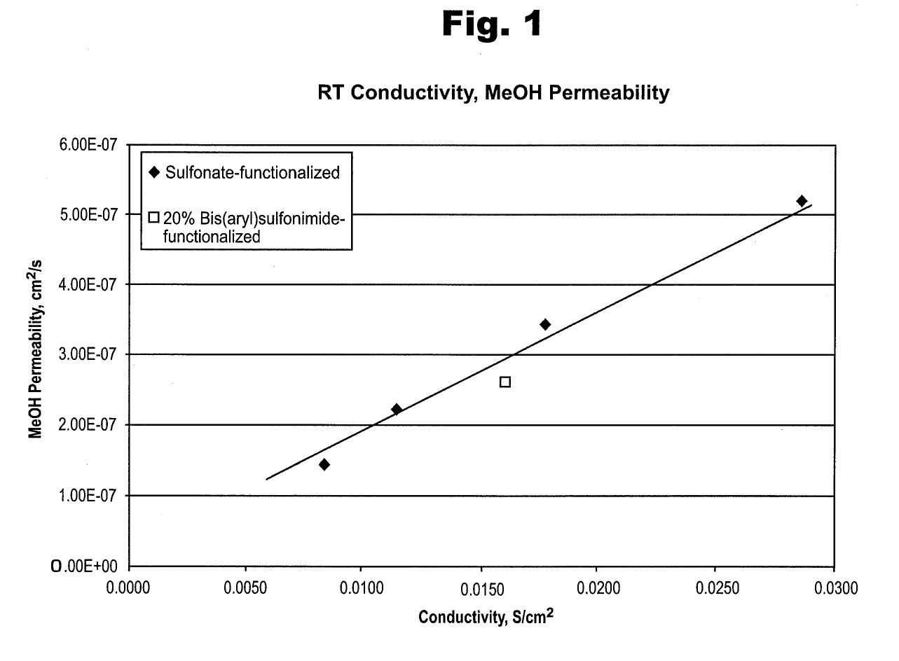

FIG. 2 is graph showing water content versus IECv for PEMs made from a sulfonic acid ion conducting polymer and the same polymer where 50% of the sulfonic acid groups are replaced with bis(aryl)sulfonimide.

### DETAILED DESCRIPTION OF THE INVENTION

As used herein, a “bis(aryl)sulfonimide” has the chemical structure

R₁—S(O)₂—NM-S(O)₂—R₂
where each of R₁ and R₂ are the same or different aryl moieties and M is H or an alkali metal cation (e.g. —Li⁺, Na⁺), or a protonated amine (e.g. —(CH₃CH₁)₃NH⁺).

Preferred aryl moieties include monovalent aromatic radicals such as phenyl, naphthyl, anthracyl, phenanthryl, pyrenyl or any of the following:

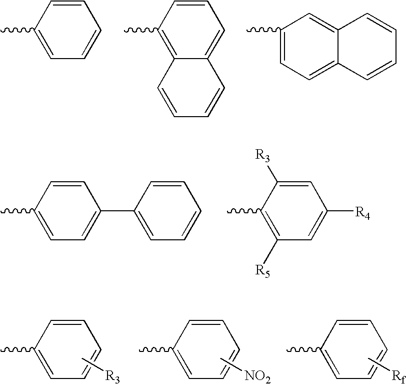

where R₃, R₄ and R₅ are independently H or linear or branched alkyl (C1-C6) and R_{f} is perfluoroalkyl. When other than H, R₃, R₄ and R₅ can be substituted in any position relative to the carbon atom that is directly connected to the sulfonimide linkage.

In preferred embodiments, R₂ is (1) an aryl group in an ion conducting polymer (such as Ar₁ and/or Ar₂ as set forth above in Formula I and elsewhere herein), (2) an aryl group in a monomer used to make an ion conducting polymer, or (3) is an aryl group that is attached to the polymer backbone via a linker. Alternatively, R₁—S(O)₂—NM-S(O)₂—R₂ can be linked via R₁ or R₂ to the polymer or copolymer, in which case the polymer need not have an aryl group in its backbone; e.g. a perfluoro alkyl polymer.

Examples of monomers comprising bis(aryl)sulfonimide groups, where Q is —S(O)₂—NH—S(O)₂—R₁, include but are not limited to:

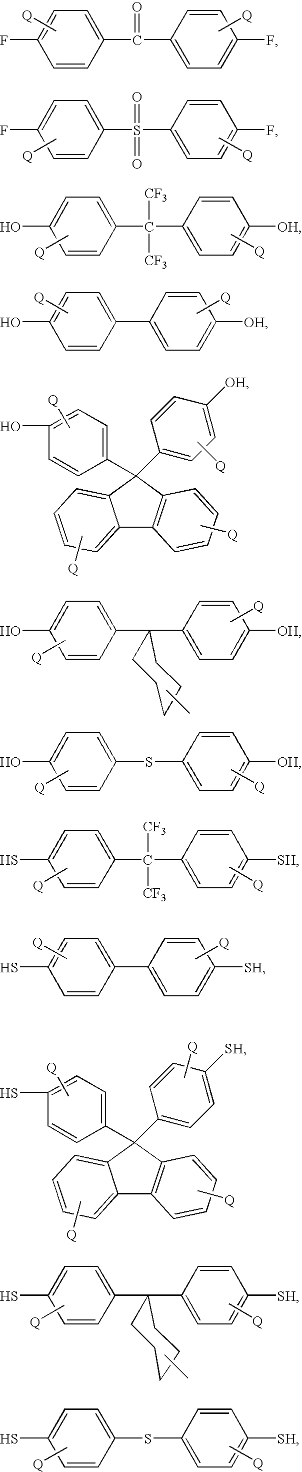

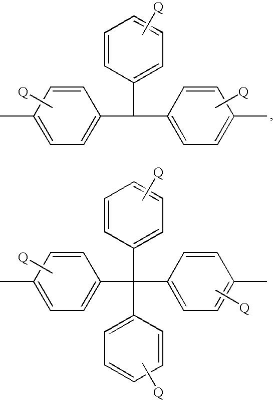

Bis(aryl)sulfonimide monomers are synthesized by first converting a sulfonate-containing monomer to the corresponding sulfonyl chloride and then reacting the sulfonyl chloride with an aromatic primary sulfonamide.

An example of a bis(aryl) sulfonimide-containing monomer (monomer 1) is set forth in Formula IV:

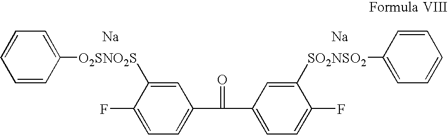

This monomer is synthesized as follows:

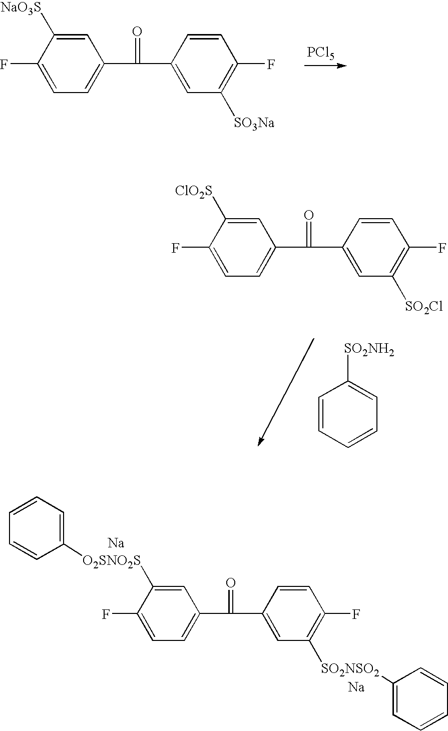

Generically, monomers of this type can be expressed as follows:

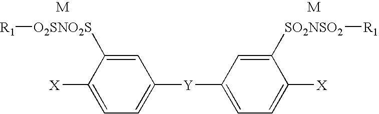

Where:
X is F or Cl
Y is C(O), S(O)₂ or P(O)-Phenyl
M is H⁺, alkali metal cation (e.g. —Li⁺, Na⁺), or a protonated amine (e.g. —(CH₃CH₂)₃NH⁺).

An ion-conductive polymer can be made by including only these bis(aryl)sulfonimide-based monomers as the protogenic species or can be combined with monomers that contain other ion conducting groups such as sulfonic acids

Preferred ion-conductive copolymers having pendant bis(aryl)sulfonimide group can be represented by Formula I:

[[—((Ar₁-T)ₜ-Ar₁-Z-(Ar₂—U)ᵤ—Ar₂-Z-)ᵢ]ₐ^{m}/(—(Ar₃—V)ᵥ—Ar₃-Z-)_{b}ⁿ/[—((Ar₄—W)_{w}—Ar₄-Z-(Ar₅—X)ₓ—Ar₅-Z-)ⱼ]_{c}^{o}/(—(Ar₆—Y)_{y}—Ar₆-Z-)_{d}^{p}/] Formula I
wherein Ar₁, Ar₂, Ar₃, Ar₄, Ar₅, and Ar₆ are aromatic moieties;
at least one of Ar₁ comprises a pendant bis(aryl)sulfonimide group;
at least one of Ar₃ comprises a pendant bis(aryl)sulfonimide group;
T, U, V W, X and Y are linking moieties;
Z is independently —O— or —S—;
i and j are independently integers greater than 1;
t, u, v, w, x, and y are independently 0 or 1
a, b, c, and d are mole fractions wherein the sum of a, b, c and d is 1, at least one of a and b is greater than 0 and at least one of c and d is greater than 0; and
m, n, o, and p are integers indicating the number of different oligomers or monomers in the copolymer.

The precursor ion conducting copolymer may also be represented by Formula II:

[[—((Ar₁-T)ₜ-Ar₁-Z-(Ar₂—U)ᵤ—Ar₂-Z-)ᵢ]ₐ^{m}/(—(Ar₃—V)ᵥ—Ar₃-Z-)_{b}ⁿ/[—((Ar₄—W)_{w}—Ar₄-Z-(Ar₅—X)ₓ—Ar₅-Z-)ⱼ]_{c}^{o}/(—(Ar₆—Y)_{y}—Ar₆-Z-)_{d}^{p}/] Formula II
wherein Ar₁, Ar₂, Ar₃, Ar₄, Ar₅, and Ar₆ are independently phenyl, substituted phenyl, napthyl, terphenyl, aryl nitrile and substituted aryl nitrile;
at least one of Ar₁ comprises a pendant bis(aryl)sulfonimide group;
at least one of Ar₃ comprises a pendant bis(aryl)sulfonimide group;
T, U, V, W, X and Y are independently a bond, —C(O)—,

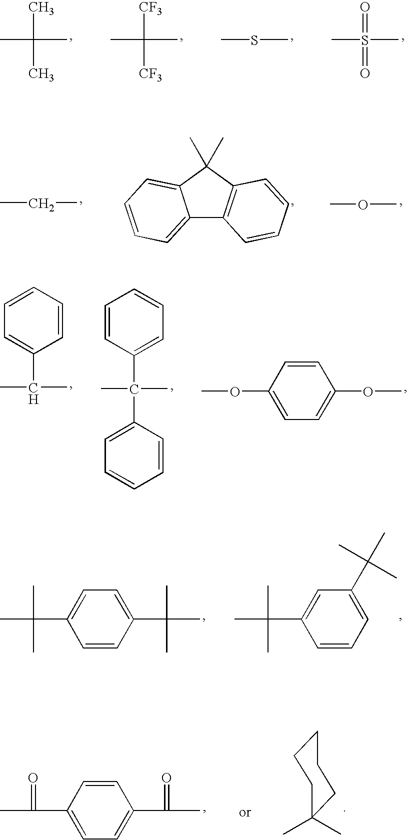

Z is independently —O— or —S—;
i and j are independently integers greater than 1;
t, u, v, w, x, and y are independently 0 or 1
a, b, c, and d are mole fractions wherein the sum of a, b, c and d is 1, at least one of a and b is greater than 0 and at least one of c and d is greater than 0; and
m, n, o, and p are integers indicating the number of different oligomers or monomers in the copolymer.

The precursor ion-conductive copolymer can also be represented by Formula III:

[[—((Ar₁-T)ₜ-Ar₁-Z-(Ar₂—U)ᵤ—Ar₂-Z-)ᵢ]ₐ^{m}/(—(Ar₃—V)ᵥ—Ar₃-Z-)_{b}ⁿ/[—((Ar₄—W)_{w}—Ar₄-Z-(Ar₅—X)ₓ—Ar₅-Z-)ⱼ]_{c}^{o}/(—(Ar₆—Y)_{y}—Ar₆-Z-)_{d}^{p}/] Formula III
wherein Ar₁, Ar₂, Ar₃, Ar₄ Ar₅, and Ar₆ are independently phenyl, substituted phenyl, napthyl, terphenyl, aryl nitrile and substituted aryl nitrile;
at least one of Ar₁ further comprises a pendant bis(aryl)sulfonimide group;
at least one of Ar₃ further comprises a pendant bis(aryl)sulfonimide group;
T, U, V, W, X and Y are independently a bond O, S, C(O), S(O₂), alkyl, branched alkyl, fluoroalkyl, branched fluoroalkyl, cycloalkyl, aryl, substituted aryl or heterocycle;
Z is independently —O— or —S—;
i and j are independently integers greater than 1;
t, u, v, w, x, and y are independently 0 or 1
a, b, c, and d are mole fractions wherein the sum of a, b, c and d is 1, at least one of a and b is greater than 0 and at least one of c and d is greater than 0; and
m, n, o, and p are integers indicating the number of different oligomers or monomers in the copolymer.

In each of the foregoing formulas:
—((Ar₁-T)ₜ-Ar₁-Z-(Ar₂—U)ᵤ—Ar₂-Z-)ᵢ] is an ion conducting oligomer where one or more of Ar₁ contains SO₃M;
(—(Ar₃—V)ᵥ—Ar₃-Z-) is an ion conducting comonomer where one or both of Ar3 contains SO₃M
—((Ar₄—W)_{w}—Ar₄-Z-(Ar₅—X)ₓ—Ar₅-Z-)ⱼ is a non ionic oligomer; and
(—(Ar₆—Y)_{y}—Ar₆-Z-) is a comonomer

In some embodiments, at least one of Ar₁ and Ar₃ comprises a sulfonic acid group in the ion conducting copolymer. In one such embodiment, the Ar₁ and Ar₃ comprising a sulfonic acid group are different from the Ar₁ and Ar₃ comprising a pendant bis(aryl)sulfonimide group.

In other embodiments, the ion conductive copolymer can be represented by formula V or formula VI:

[[—((Ar₁(Q)-T)ₜ-Ar₁-Z-(Ar₂—U)ᵤ—Ar₂-Z-)ᵢ]ₐ^{m}/(—(Ar₃(Q)-V)ᵥ—Ar₃-Z-)_{b}ⁿ/[—((Ar₄—W)_{w}—Ar₄-Z-(Ar₅—X)ₓ—Ar₅-Z-)ⱼ]_{c}^{o}/(—(Ar₆—Y)_{y}—Ar₆-Z-)_{d}^{p}/] Formula IV

or

[[—((Ar₁(L-R₁-Q)-T)ₜ-Ar₁-Z-(Ar₂—U)ᵤ—Ar₂-Z-)ᵢ]ₐ^{m}/(—(Ar₃(L-R₁-Q)-V)ᵥ—Ar₃-Z-)_{b}ⁿ/[—((Ar₄—W)_{w}—Ar₄-Z-(Ar₅—X)ₓ—Ar₅-Z-)ⱼ]_{c}^{o}/(—(Ar₆—Y)_{y}—Ar₆-Z-)_{d}^{p}/] Formula V
where Q is a pendant moiety having the formula —S(O)₂—NM-S(O)₂—R₂ where
M is H or an alkali metal cation
L-R₁-Q is a pendant moiety
L is a linker group selected from the group consisting of a bond, —O—, —S—, —S(O)2), —C(O), or C1-C6 alkyl;
R₁ and R₂ are independently

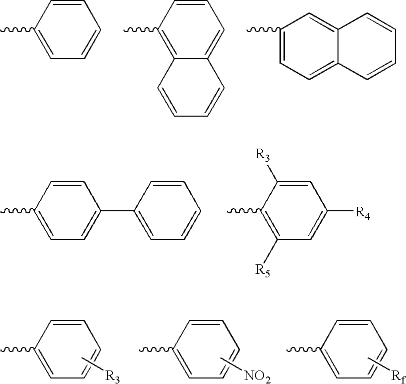

where R₃, R₄ and R₅ are independently H or linear or branched alkyl (C1-C6) and R_{f} is perfluoroalkyl
Ar₁, Ar₂, Ar₃, Ar₄ Ar₅, and Ar₆ are aromatic moieties;
T, U, V, W, X and Y are linking moieties;
Z is independently —O— or —S—;
i and j are independently integers greater than 1;
t, u, v, w, x, and y are independently 0 or 1;
a, b, c, and d are mole fractions wherein the sum of a, b, c and d is 1, at least one of a and b is greater than 0 and at least one of c and d is greater than 0; and
m, n, o, and p are integers indicating the number of different oligomers or monomers in the copolymer.

In formula IV or V, in one embodiment, Ar₁, Ar₂, Ar₃ and Ar₄ are independently phenyl, substituted phenyl, napthyl, terphenyl, aryl nitrile and substituted aryl nitrile; and
T, U, V, W, X and Y are independently a bond, —C(O)—,

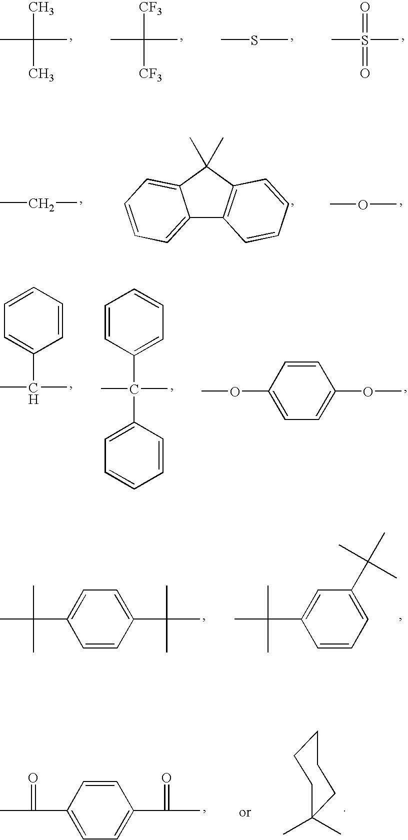

In another embodiment of formula IV and V, Ar₁, Ar₂, Ar₃ and Ar₄ are independently phenyl, substituted phenyl, napthyl, terphenyl, aryl nitrile and substituted aryl nitrile; and T, U, V, W, X and Y are independently a bond O, S, C(O), S(O₂), alkyl, branched alkyl, fluoroalkyl, branched fluoroalkyl, cycloalkyl, aryl, substituted aryl or heterocycle.

In some embodiments of formula IV and V, at least one of Ar₁ and Ar₃ comprises a sulfonic acid group. In some embodiments, the Ar₁ and Ar₃ comprising the sulfonic acid group are different from the Ar₁ and Ar₃ comprising Q or L-R₁-Q.

Generally at least 10% and as high as 100% of the ion conducting groups in the polymer are bis(aryl)sulfonimides. However, it is preferred that bis(aryl)sulfonimides constitute 10% to 60% of the ion conducting groups and that sulfonic acid groups constitute 40% to 90% of the ion conducting groups.

In preferred embodiments for each of the forgoing formulas, i and j are independently from 1 to 12, preferably from 2 to 12, more preferably from 3 to 8 and most preferably from 4 to 6.

The mole fraction “a” of ion-conducting oligomer in the copolymer is between 0.1 and 0.9, preferably between 0.3 and 0.9, more preferably from 0.3 to 0.7 and most preferably from 0.3 to 0.5.

The mole fraction “b” of ion conducting monomer in the copolymer is preferably from 0 to 0.5, more preferably from 0.1 to 0.4 and most preferably from 0.1 to 0.3.

The mole fraction of “c” of non-ion conductive oligomer is preferably from 0 to 0.3, more preferably from 0.1 to 0.25 and most preferably from 0.01 to 0.15.

The mole fraction “d” of non-ion conducting monomer in the copolymer is preferably from 0 to 0.7, more preferably from 0.2 to 0.5 and most preferably from 0.2 to 0.4.

In some instances, b, c and d are all greater then zero. In other cases, a and c are greater than zero and b and d are zero. In other cases, a is zero, b is greater than zero and at least c or d or c and d are greater than zero. Nitrogen is generally not present in the copolymer backbone.

The indices m, n, o, and p are integers that take into account the use of different monomers and/or oligomers in the same copolymer or among a mixture of copolymers, where m is preferably 1, 2 or 3, n is preferably 1 or 2, o is preferably 1 or 2 and p is preferably 1, 2, 3 or 4.

In some embodiments at least two of Ar₂, Ar₃ and Ar₄ are different from each other. In another embodiment Ar₂ Ar₃ and Ar₄ are each different from the other.

In some embodiments, when there is no hydrophobic oligomer, i.e. when c is zero in Formulas I, II, or III: (1) the precursor ion conductive monomer used to make the ion-conducting polymer is not 2,2′ disulfonated 4,4′ dihydroxy biphenyl or (2) the ion conductive polymer does not contain the ion-conducting monomer that is formed using this precursor ion conductive monomer.

A random ion conducting copolymer is set forth in Formula VI

[—(Ar₁-T)₁-Ar₁-Z-(Ar₂—U)ᵤ—Ar₂-Z-)ᵢ]ₐ^{m}/[—((Ar₄—W)_{w}—Ar₄-Z-(Ar₅—X)ₓ—Ar₅-Z-)ⱼ]_{c}^{o}/ Formula VI

where the definitions for each of the components are set forth above, except that the sum of mole fractions a plus b equal 1 (where a is preferably from 0.2 to 0.5 and c is from 0.5 to 0.08) and i and j each equal 1.

An example of a random copolymer containing bis(aryl)sulfonimide ion conducting groups and sulfonic acid ion conducting groups is set forth in Formula VII

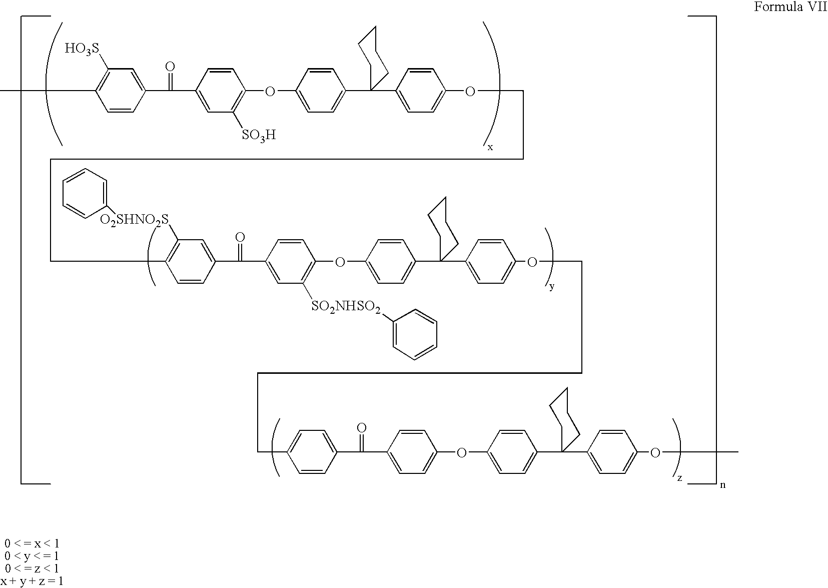

It is preferred that x is from 0.2 to 0.4, y is from 0.1 to 0.3 and z is from 0.4 to 0.7.

The following are some of the other monomers used to make ion-conductive copolymers.

1) Precursor Difluoro-end monomers

| | | Molecular | |
|---|---|---|---|
| Acronym | Full name | weight | Chemical structure |
| Bis K | 4,4′-Difluorobenzophenone | 218.20 | 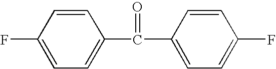 |
| Bis SO₂ | 4,4′-Difluorodiphenylsulfone | 254.25 | 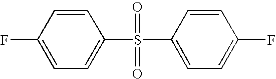 |
| S-Bis K | 3,3′-disulfonated-4,4′-difluorobenzophone | 422.28 | 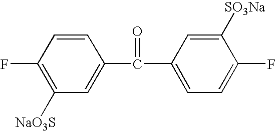 |

2) Precursor Dihydroxy-end monomers

| | | | |
|---|---|---|---|
| Bis AF(AF or 6F) | 2,2-Bis(4-hydroxyphenyl)hexafluoropropane or4,4′-(hexafluoroisopropylidene)diphenol | 336.24 | 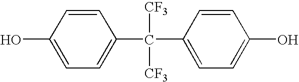 |
| BP | Biphenol | 186.21 | 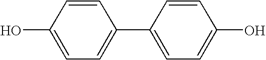 |
| Bis FL | 9,9-Bis(4-hydroxyphenyl)fluorene | 350.41 | 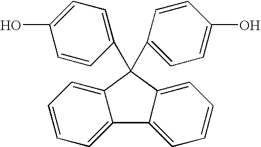 |
| Bis Z | 4,4′-cyclohexylidenebisphenol | 268.36 | 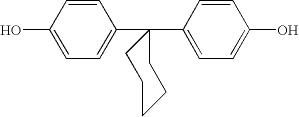 |
| Bis S | 4,4′-thiodiphenol | 218.27 | 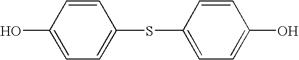 |

3) Precursor Dithiol-end monomer

| | | Molec- | |
|---|---|---|---|
| Acro- | Full | ular | |
| nym | name | weight | Chemical Structure |
| | 4,4′-thiolbisbenzenethiol | | 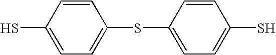 |

In the foregoing, it should be understood that OH can replace SH groups and vice versa.

Ion conducting copolymers and the monomers used to make them and which are not otherwise identified herein can also be used. Such ion conducting copolymers and monomers include those disclosed in U.S. patent application Ser. No. 09/872,770, filed Jun. 1, 2001, Publication No. US 2002-0127454 A1, published Sep. 12, 2002, entitled “Polymer Composition”; U.S. patent application Ser. No. 10/351,257, filed Jan. 23, 2003, Publication No. US 2003-0219640 A1, published Nov. 27, 2003, entitled “Acid Base Proton Conducting Polymer Blend Membrane”; U.S. patent application Ser. No. 10/438,186, filed May 13, 2003, Publication No. US 2004-0039148 A1, published Feb. 26, 2004, entitled “Sulfonated Copolymer”; U.S. patent application Ser. No. 10/438,299, filed May 13, 2003, entitled “Ion-conductive Block Copolymers,” published Jul. 1, 2004, Publication No. 2004-0126666; U.S. application Ser. No. 10/449,299, filed Feb. 20, 2003, Publication No. US 2003-0208038 A1, published Nov. 6, 2003, entitled “Ion-conductive Copolymer”; U.S. patent application Ser. No. 10/438,299, filed May 13, 2003, Publication No. US 2004-0126666; U.S. patent application Ser. No. 10/987,178, filed Nov. 12, 2004, entitled “Ion-conductive Random Copolymer”, Publication No. 2005-0181256 published Aug. 18, 2005; U.S. patent application Ser. No. 10/987,951, filed Nov. 12, 2004, Publication No. 2005-0234146, published Oct. 20, 2005, entitled “Ion-conductive Copolymers Containing First and Second Hydrophobic Oligomers;” U.S. patent application Ser. No. 10/988,187, filed Nov. 11, 2004, Publication No. 2005-0282919, published Dec. 22, 2005, entitled “Ion-conductive Copolymers Containing One or More Hydrophobic Oligomers”; and U.S. patent application Ser. No. 11/077,994, filed Mar. 11, 2005, Publication No. 2006-004110, published Feb. 23, 2006, each of which are expressly incorporated herein by reference. Other comonomers include those used to make sulfonated trifluorostyrenes (U.S. Pat. No. 5,773,480), acid-base polymers, (U.S. Pat. No. 6,300,381), poly arylene ether sulfones (U.S. Patent Publication No. US2002/0091225A1); graft polystyrene (Macromolecules 35:1348 (2002)); polyimides (U.S. Pat. No. 6,586,561 and J. Membr. Sci. 160:127 (1999)) and Japanese Patent Applications Nos. JP2003147076 and JP2003055457, each of which are expressly identified herein by reference.

Although the copolymers of the invention have been described primarily in connection with the use of arylene polymers, in principle the ion conducting copolymers need not be arylene but rather may have aliphatic or perfluorinated aliphatic backbones containing bis(aryl)sulfonimides attached directly to but not a part of such backbones.

The mole percent of ion-conducting groups when two ion-conducting group is present in a comonomer is preferably between 20 and 70%, or more preferably between 25 and 60%, and most preferably between 30 and 50%. When more than one conducting group is contained within the ion-conducting monomer, such percentages are multiplied by the total number of ion-conducting groups per monomer. Thus, in the case of a monomer comprising two sulfonic acid groups, the preferred sulfonation is 40 to 140%, more preferably 50 to 120% and most preferably 60 to 100%. Alternatively, the amount of ion-conducting group can be measured by the ion exchange capacity (IEC). By way of comparison, Nafion® typically has a ion exchange capacity of 0.9 meq per gram. In the present invention, it is preferred that the IEC be between 0.7 and 3.0 meq per gram, more preferably between 0.8 and 2.5 meq per gram, and most preferably between 1.0 and 2.0 meq per gram.

PEM's may be fabricated by solution casting of the ion-conductive copolymer in conjunction with heat or radiation to induce cross-linking among the copolymers in the PEM.

When cast into a membrane and cross-linked, the PEM can be used in a fuel cell. It is preferred that the membrane thickness be between 0.1 to 10 mils, more preferably between 1 and 6 mils, most preferably between 1.5 and 2.5 mils.

As used herein, a membrane is permeable to protons if the proton flux is greater than approximately 0.005 S/cm, more preferably greater than 0.01 S/cm, most preferably greater than 0.02 S/cm.

As used herein, a membrane is substantially impermeable to methanol if the methanol transport across a membrane having a given thickness is less than the transfer of methanol across a Nafion membrane of the same thickness. In preferred embodiments the permeability of methanol is preferably 50% less than that of a Nafion membrane, more preferably 75% less and most preferably greater than 80% less as compared to the Nafion membrane.

After the ion-conducting copolymer has been formed into a membrane, it may be used to produce a catalyst coated membrane (CCM). As used herein, a CCM comprises a PEM when at least one side and preferably both of the opposing sides of the PEM are partially or completely coated with catalyst. The catalyst is preferable a layer made of catalyst and ionomer. Preferred catalysts are Pt and Pt—Ru. Preferred ionomers include Nafion and other ion-conductive polymers. In general, anode and cathode catalysts are applied onto the membrane using well established standard techniques. For direct methanol fuel cells, platinum/ruthenium catalyst is typically used on the anode side while platinum catalyst is applied on the cathode side. For hydrogen/air or hydrogen/oxygen fuel cells platinum or platinum/ruthenium is generally applied on the anode side, and platinum is applied on the cathode side. Catalysts may be optionally supported on carbon. The catalyst is initially dispersed in a small amount of water (about 100 mg of catalyst in 1 g of water). To this dispersion a 5% ionomer solution in water/alcohol is added (0.25-0.75 g). The resulting dispersion may be directly painted onto the polymer membrane. Alternatively, isopropanol (1-3 g) is added and the dispersion is directly sprayed onto the membrane. The catalyst may also be applied onto the membrane by decal transfer, as described in the open literature (Electrochimica Acta, 40: 297 (1995)).

The CCM is used to make MEA's. As used herein, an MEA refers to an ion-conducting polymer membrane made from a CCM according to the invention in combination with anode and cathode electrodes positioned to be in electrical contact with the catalyst layer of the CCM.

The electrodes are in electrical contact with the catalyst layer, either directly or indirectly via gas diffusion or other conductive layer, so that they are capable of completing an electrical circuit which includes the CCM and a load to which the fuel cell current is supplied. More particularly, a first catalyst is electrocatalytically associated with the anode side of the PEM so as to facilitate the oxidation of hydrogen or organic fuel. Such oxidation generally results in the formation of protons, electrons and, in the case of organic fuels, carbon dioxide and water. Since the membrane is substantially impermeable to molecular hydrogen and organic fuels such as methanol, as well as carbon dioxide, such components remain on the anodic side of the membrane. Electrons formed from the electrocatalytic reaction are transmitted from the anode to the load and then to the cathode. Balancing this direct electron current is the transfer of an equivalent number of protons across the membrane to the cathodic compartment. There an electrocatalytic reduction of oxygen in the presence of the transmitted protons occurs to form water. In one embodiment, air is the source of oxygen. In another embodiment, oxygen-enriched air or oxygen is used.

The membrane electrode assembly is generally used to divide a fuel cell into anodic and cathodic compartments. In such fuel cell systems, a fuel such as hydrogen gas or an organic fuel such as methanol is added to the anodic compartment while an oxidant such as oxygen or ambient air is allowed to enter the cathodic compartment. Depending upon the particular use of a fuel cell, a number of cells can be combined to achieve appropriate voltage and power output. Such applications include electrical power sources for residential, industrial, commercial power systems and for use in locomotive power such as in automobiles. Other uses to which the invention finds particular use includes the use of fuel cells in portable electronic devices such as cell phones and other telecommunication devices, video and audio consumer electronics equipment, computer laptops, computer notebooks, personal digital assistants and other computing devices, GPS devices and the like. In addition, the fuel cells may be stacked to increase voltage and current capacity for use in high power applications such as industrial and residential sewer services or used to provide locomotion to vehicles. Such fuel cell structures include those disclosed in U.S. Pat. Nos. 6,416,895, 6,413,664, 6,106,964, 5,840,438, 5,773,160, 5,750,281, 5,547,776, 5,527,363, 5,521,018, 5,514,487, 5,482,680, 5,432,021, 5,382,478, 5,300,370, 5,252,410 and 5,230,966.

Such CCM and MEM's are generally useful in fuel cells such as those disclosed in U.S. Pat. Nos. 5,945,231, 5,773,162, 5,992,008, 5,723,229, 6,057,051, 5,976,725, 5,789,093, 4,612,261, 4,407,905, 4,629,664, 4,562,123, 4,789,917, 4,446,210, 4,390,603, 6,110,613, 6,020,083, 5,480,735, 4,851,377, 4,420,544, 5,759,712, 5,807,412, 5,670,266, 5,916,699, 5,693,434, 5,688,613, 5,688,614, each of which is expressly incorporated herein by reference.

The CCM's and MEA's of the invention may also be used in hydrogen fuel cells that are known in the art. Examples include 6,630,259; 6,617,066; 6,602,920; 6,602,627; 6,568,633; 6,544,679; 6,536,551; 6,506,510; 6,497,974, 6,321,145; 6,195,999; 5,984,235; 5,759,712; 5,509,942; and 5,458,989 each of which are expressly incorporated herein by reference.

### EXAMPLE 1

### Synthesis of Monomer 1

4,4′-Difluorobenzophenone-3,3′-disulfonate sodium salt (100 g, 0.237 mol) is vacuum dried and ground in a mortar and pestle with PCl₅ (10 g, 0.480 mol). The intimate mixture of the two powders is placed in an Erlenmeyer flask with a magnetic stir bar. Anhyrdrous N,N-dimethylformamide (DMF) (17 ml) is added to the mixture and worked into the powder mechanically until it forms a paste. The paste is heated over a steam bath for 10 minutes after which the slurry is precipitated into ice water. The precipitated powder is recovered by vacuum filtration, slurried with ice water and filtered a second time. The recovered material is dried in an oven at 80° C. to yield pure 4,4′-Difluorobenzophenone-3,3′-disulfonyl chloride.

Benzenesulfonamide (30.29 g, 0.193 mol) is oven dried and dissolved in 160 mL of anhydrous acetonitrile to which is added diisopropylethylamine (49.81 g, 0.385 mol). The mixture is allowed to stir for 1 hour and cooled to 5° C. in an ice bath. 4,4′-Difluorobenzophenone-3,3′-disulfonyl chloride (40.0 g, 0.0963 mol) is vacuum dried and added slowly to the acetonitrile solution so that the temperature does not exceed 10° C. After completing the addition of the sulfonyl chloride, the ice bath is removed and the reaction mixture is stirred at room temperature for 16 hours. To the reaction mixture is added 35% HCl (150 ml) and dichloromethane (150 ml). The organic phase is separated and washed with a solution of 1M Na₂CO₃ (200 mL) The product is precipitated as a white powder and is recovered by vacuum filtration. The powder is recrystallized in a 2:1 mixture of ethanol and water to yield the pure product monomer 1.

### EXAMPLE 2

Polymer synthesis and membrane fabrication. 4,4′-Difluorobenzophenone (6.15 g, 0.0282 mol), 4,4′-difluorobenzophenone-3,3′-disulfonate sodium salt (5.11 g, 0.0121 mol), monomer 1 (2.12 g, 0.00302 mol), cyclohexylidenebisphenol (11.62 g 0.0433 mol), and potassium carbonate (7.78 g 0.0563 mol) are dissolved in DMSO (120 g) and Toluene (60 g) and added to a 250 mL 3-neck flask equipped with a Dean-Stark trap, reflux condenser and nitrogen inlet. The reaction mixture is heated at 130° C. for 4 hours and then 170° C. for 2 hours whereupon the reaction mixture is precipitated into Methanol to recover the bis(aryl)sulfonimide-functionalized polymer. The recovered polymer is dissolved in NMP and cast into a membrane, washed with water, treated with 1.5M H₂SO₄, rinsed and dried to result in a proton exchange membrane.

### EXAMPLE 3

A monomer (Monomer 2) was synthesized as in Example 1, except that 2,4,6-trimethylbenzenesulfonamide was used instead of benzenesulfonamide.

### EXAMPLE 4

A monomer (Monomer 3) was synthesized as in Example 1, except that naphthalenesulfonamide was used instead of benzenesulfonamide.

### EXAMPLE 5

A polymer was synthesized as in Example 2, except that 2,7-Dihydroxynaphthalene was used instead of cyclohexylidenebisphenol.

### EXAMPLE 6

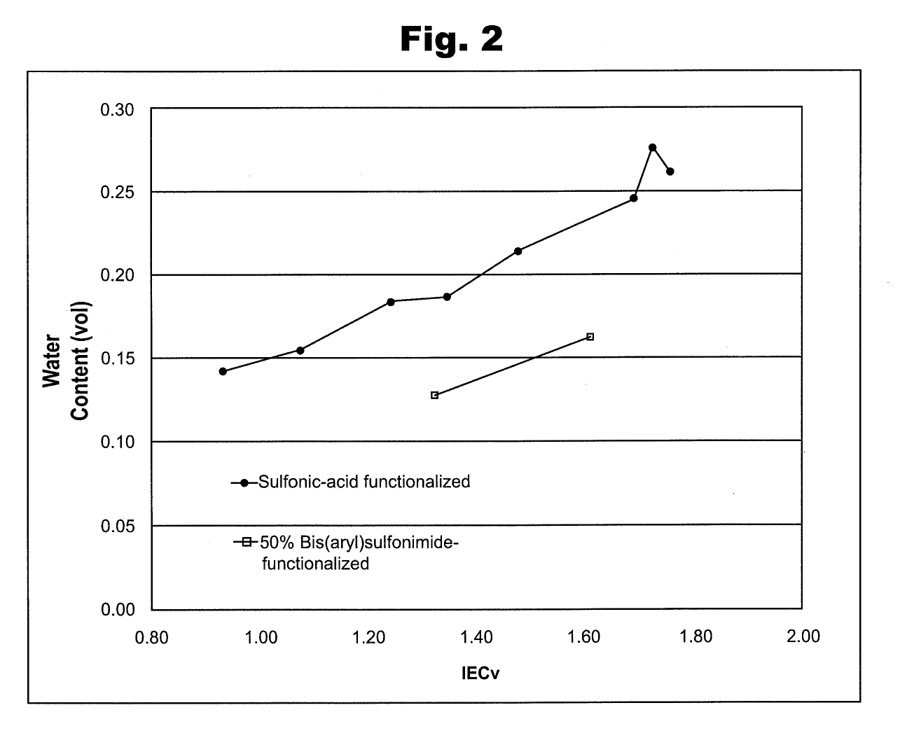

A polymer was synthesized as in Example 2, except that the moles of reagents were as follows: 4,4′-Difluorobenzophenone (0.0226 mol), 4,4′-difluorobenzophenone-3,3′-disulfonate sodium salt (0.008437 mol), monomer 1 (0.008437 mol), cyclohexylidenebisphenol (11.62 g 0.03948 mol). Data for a PEM made with this polymer is set forth in FIG. 2.

### EXAMPLE 7

A polymer was synthesized as in Example 2, except that Monomer 2 was used instead of Monomer 1.

### EXAMPLE 8

A polymer was synthesized as in Example 2, except that Monomer 3 was used instead of Monomer 1.

What is claimed is:

1. An ion-conducting copolymer comprising (i) at least one of an ion conducting monomer and ion-conducting oligomer and (ii) at least one of a non-ionic monomer and a non-ionic oligomer, covalently linked to each other, wherein at least one of said ion conducting oligomer and said ion conducting monomer comprises a pendant bis(aryl)sulfonimide group.

2. An ion conductive copolymer having the formula
[[—((Ar₁-T)ₜ-Ar₁-Z-(Ar₂—U)ᵤ—Ar₂-Z-)ᵢ]ₐ^{m}/(—(Ar₃—V)ᵥ—Ar₃-Z-)_{b}ⁿ/[—((Ar₄—W)_{w}—Ar₄-Z-(Ar₅—X)ₓ—Ar₅-Z-)ⱼ]_{c}^{o}/(—(Ar₆—Y)_{y}—Ar₆-Z-)_{d}^{p}/]
wherein Ar₁, Ar₂, Ar₃, Ar₄, Ar₅, and Ar₆ are aromatic moieties;
at least one of Ar₁ comprises a pendant bis(aryl)sulfonimide group;
at least one of Ar₃ comprises a pendant bis(aryl)sulfonimide group;
T, U, V W, X and Y are linking moieties;
Z is independently —O— or —S—;
i and j are independently integers greater than 1;
t, u, v, w, x, and y are independently 0 or 1
a, b, c, and d are mole fractions wherein the sum of a, b, c and d is 1, at least one of a and b is greater than 0 and at least one of c and d is greater than 0; and
m, n, o, and p are integers indicating the number of different oligomers or monomers in the copolymer.

3. The ion-conductive copolymer of claim 2 wherein Ar₁, Ar₂, Ar₃ and Ar₄ are independently phenyl, substituted phenyl, napthyl, terphenyl, aryl nitrile and substituted aryl nitrile; and
T, U, V, W, X and Y are independently a bond O, S, C(O), S(O₂), alkyl, branched alkyl, fluoroalkyl, branched fluoroalkyl, cycloalkyl, aryl, substituted aryl or heterocycle.

4. The ion-conductive copolymer of claim 2 wherein, Ar₁, Ar₂, Ar₃ and Ar₄ are independently phenyl, substituted phenyl, napthyl, terphenyl, aryl nitrile and substituted aryl nitrile; and T, U, V, W, X and Y are independently a bond, —C(O)—,

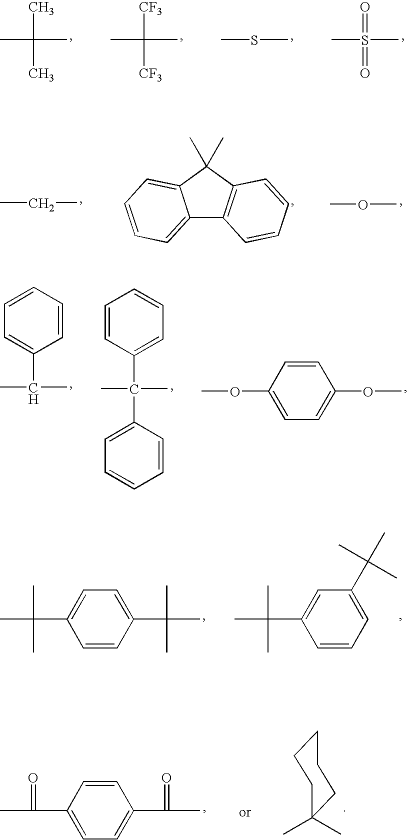

5. The ion conducting copolymer of claim 2 wherein at least one of said Ar₁ and Ar₃ comprises a sulfonic acid group.

6. The ion conducting copolymer of claim 5 wherein said Ar₁ and Ar₃ comprising a sulfonic acid group are different from the Ar₁ and Ar₃ comprising a pendant bis(aryl)sulfonimide group.

7. An ion conductive copolymer having the formula
[[—((Ar₁(Q)-T)ₜ-Ar₁-Z-(Ar₂—U)ᵤ—Ar₂-Z-)ᵢ]ₐ^{m}/(—(Ar₃(Q)-V)ᵥ—Ar₃-Z-)_{b}ⁿ/[—((Ar₄—W)_{w}—Ar₄-Z-(Ar₅—X)ₓ—Ar₅-Z-)ⱼ]_{c}^{o}/(—(Ar₆—Y)_{y}—Ar₆-Z-)_{d}^{p}/]
or
[[—((Ar₁(L-R₁-Q)-T)ₜ-Ar₁-Z-(Ar₂—U)ᵤ—Ar₂-Z-)ᵢ]ₐ^{m}/(—(Ar₃(L-R₁-Q)-V)ᵥ—Ar₃-Z-)_{b}ⁿ/[—((Ar₄—W)_{w}—Ar₄-Z-(Ar₅—X)ₓ—Ar₅-Z-)ⱼ]_{c}^{o}/(—(Ar₆—Y)_{y}—Ar₆-Z-)_{d}^{p}/]
where Q is a pendant moiety having the formula S(O)₂—NM-S(O)₂—R₂ where M is H or an alkali metal cation
L-R₁-Q is a pendant moiety
L is a linker group selected from the group consisting of a bond, —O—, —S—, —S(O)2), —C(O), or C1-C6 alkyl;
R₁ and R₂ are independently 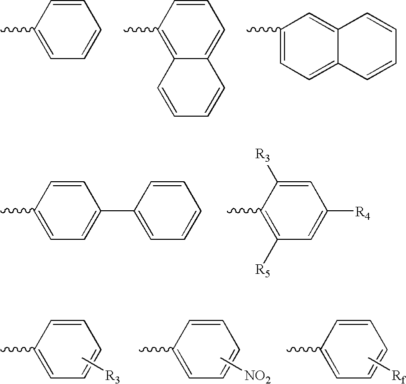
where R₃, R₄ and R₅ are independently H or linear or branched alkyl (C1-C6) and R_{f} is perfluoroalkyl
Ar₁, Ar₂, Ar₃, Ar₄ Ar₅, and Ar₆ are aromatic moieties;
T, U, V W, X and Y are linking moieties;
Z is independently —O— or —S—;
i and j are independently integers greater than 1;
t, u, v, w, x, and y are independently 0 or 1;
a, b, c, and d are mole fractions wherein the sum of a, b, c and d is 1, at least one of a and b is greater than 0 and at least one of c and d is greater than 0; and
m, n, o, and p are integers indicating the number of different oligomers or monomers in the copolymer.

8. The ion conducting polymer of claim 7 where Ar₁, Ar₂, Ar₃ and Ar₄ are independently phenyl, substituted phenyl, napthyl, terphenyl, aryl nitrile and substituted aryl nitrile; and
T, U, V, W, X and Y are independently a bond, —C(O)—,

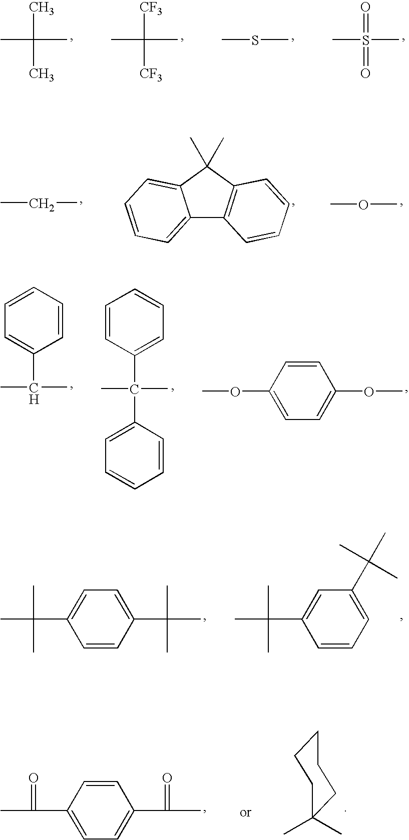

9. The ion conducting polymer of claim 7 where Ar₁, Ar₂, Ar₃ and Ar₄ are independently phenyl, substituted phenyl, napthyl, terphenyl, aryl nitrile and substituted aryl nitrile; and
T, U, V, W, X and Y are independently a bond O, S, C(O), S(O)₂, alkyl, branched alkyl, fluoroalkyl, branched fluoroalkyl, cycloalkyl, aryl, substituted aryl or heterocycle.

10. The ion conducting polymer of claim 7 wherein at least one of said Ar₁ and Ar₃ comprises a sulfonic acid group.

11. The ion conducting copolymer of claim 7 wherein said Ar₁ and Ar₃ comprising a sulfonic acid group are different from the Ar₁ and Ar₃ comprising Q or L-R₁-Q.

12. A polymer electrolyte membrane (PEM) comprising the ion-conducting copolymer of claim 1, 2 or 7.

13. A catalyst coated membrane (CCM) comprising the PEM of claim 12 wherein all or part of at least one opposing surface of said PEM comprises a catalyst layer.

14. A membrane electrode assembly (MEA) comprising the CCM of claim 13.

15. A fuel cell comprising the PEM of claim 12.

16. The fuel cell of claim 15 comprising a hydrogen fuel cell.

17. The fuel cell of claim 15 comprising a methanol fuel cell.

18. An electronic device comprising the fuel cell of claim 15.

19. A power supply comprising the fuel cell of claim 15.

20. An electric motor comprising the fuel cell of claim 15.

21. A vehicle comprising the electric motor of claim 20.
